(19) United States
(12) Patent Application Publication
(10) Pub. No.: US 2019/0226629 A1
(43) Pub. Date: Jul. 25, 2019

(54) SUPPORTING DEVICE

(71) Applicant: SYNCMOLD ENTERPRISE CORP., New Taipei City (TW)

(72) Inventors: Yan-Ying CHEN, New Taipei City (TW); Ching-Hui YEN, New Taipei City (TW)

(21) Appl. No.: 16/242,412

(22) Filed: Jan. 8, 2019

Related U.S. Application Data
(60) Provisional application No. 62/619,517, filed on Jan. 19, 2018.

(30) Foreign Application Priority Data
Oct. 9, 2018 (TW) 107213652

(51) Int. Cl. F16M 11/04; F16M 11/20

(52) U.S. Cl. CPC F16M 11/046; F16M 11/10; F16M 2200/047; F16M 11/2014

(57) ABSTRACT

A supporting device including an upright, a diverting member, a connecting element, a holder, and an adjustable counter-weight module is provided. The diverting member is disposed on the upright, the connecting element is partially disposed around the diverting member, the holder is slidably disposed on the upright and connected to the connecting element, and the holder is to support the display. The adjustable counter-weight module is connected to the connecting element, and includes a plurality of counter-weight units. When an external force is applied to move the display relative to the upright, the connecting element drives the counter-weight units connected to the connecting element to move simultaneously. When the external force is removed, the display stops relative to the upright.

### CROSS REFERENCE TO RELATED APPLICATION

This application claims the benefit of U.S. Provisional Application Ser. No. 62/619,517 filed on Jan. 19, 2018, and the benefit of Taiwan Patent Application Serial No. 107213652 filed on Oct. 9, 2018. The entirety of each said Application is incorporated herein by reference.

### BACKGROUND OF THE INVENTION

### 1. Field of the Invention

The present invention relates to a supporting device, more particularly, to a supporting device having an adjustable counter-weight module.

### 2. Description of Related Art

Taiwan utility patent No. M469418 discloses a known display elevation device with constant force spring modules, including a base body, a frame, three constant spring modules and three linkages. The base body is for a display to attach on, and the frame is slidably disposed on the base body. Each of the constant force spring modules is removably disposed on the base body. Each of the constant force spring modules includes a constant force spring and a connecting member. Each connecting member is disposed on a free end of each the constant force spring correspondingly. Each of the linkages is respectively connected to one of the aforementioned connecting members, and then to the frame. For example, assuming above mentioned three constant spring modules have weight bearing capacities of 1.5 kg, 3 kg and 5 kg, a user may select the appropriate constant force spring module according to the weight of the attached display. Once the constant force spring module is selected, one of the linkages is respectively connected to corresponding connecting element and the frame. Hence the connecting element and the frame are in a linked state, and elasticity of the constant force spring module enables the display to move and stop at any selected position.

However, the shortcoming of the known display elevation device is that structure is complicated resulted from multiple sets of constant force spring modules are required. It is further complicated when the weight of the display does not match the load of the constant force spring module because the elevation device has to be opened to change the constant force spring modules.

### SUMMARY OF THE INVENTION

In order to solve the abovementioned problems, the object of the present invention is to provide a supporting device which receives and enables a display to move relative to the upright and stop at any position. The supporting structure of the present invention includes an adjustable counter-weight module which is easy to adjust and adopt to displays of different weights.

The invention provides a supporting device for supporting a display. The supporting device comprises an upright, a diverting member, a connecting element, a holder and an adjustable counter-weight module. The diverting member is disposed on the upright. The connecting element is partially disposed around the diverting member. The holder is slidably disposed on the upright, connecting to the connecting element, and supporting the display. The adjustable counter-weight module is connected to the connecting element and includes a plurality of counter-weight units. The display, the holder, and the adjustable counter-weight module are in a static balancing state through a presetting number of the counter-weight units moving along with the connecting element. Thus, the display is able to move relative to the upright and leads the connecting element to drive the counter-weight units to move simultaneously when an external force is applied to the display, and the display is stopped relative to the upright at any position when the external force is removed.

The adjustable counter-weight module further includes a weight bearing element connected to the connecting element. The connecting element leads the weight bearing element to move down or up, and at least one of the counter-weight units moves down or up along with the weight bearing element when the display moves up or down relative to the upright.

The adjustable counter-weight module further includes a housing for the counter-weight units disposed therein.

The adjustable counter-weight module further includes a pin, and the counter-weight units are disposed stacked. Each of the counter-weight units has a first hole and a second hole. The pin is adapted to selectively insert into the second hole of any one of the counter-weight units.

In an embodiment, the weight bearing element includes a plurality of third holes and passes through the first holes of the counter-weight units along a first axis. The second holes correspond to the third holes for the pin penetrating through a through groove of the housing to insert in one of the second holes. While the external force is driving the display and the holder to move up or down relative to the upright, the connecting member leads the weight bearing element to move down or up, and simultaneously drives the counter-weight units between one end of the weight bearing element and the pin to move down or up.

The upright includes a first sliding groove and a second sliding groove. The holder includes a first sliding element. A plurality of first friction elements of the first sliding element and a plurality of second friction elements of the weight bearing element are respectively disposed in the first sliding groove and the second groove. The weight bearing element is connected to the connecting element and disposed between the upright and the housing. When the holder is moving relative to the upright, the first friction elements slide in the first sliding groove and the second friction elements slide in the second sliding groove.

In another embodiment, the housing includes a first through groove and a second through groove corresponding to the first through groove. The weight bearing element further includes a fourth hole. The pin sequentially penetrates the first through groove, one of the second holes, the second through groove and the fourth hole. While the holder is moving up or down relative to the upright, the connecting member drives the weight bearing element to move down or up, and the counter-weight units above the pin move up or down simultaneously.

The adjustable counter-weight module includes a positioning rod for the counter-weight units to be sleeved thereto, and the counter-weight units are adapted to move up or down with respect to the positioning rod.

The connecting element has a first end and a second end corresponding to the first end, wherein the holder is connected to the first end, and the adjustable counter-weight module is connected to the second end when the connecting element is partially disposed around the diverting member. The diverting member is a fixed pulley structure.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the first embodiment of the supporting device of the present invention;

FIG. 2 is a partial perspective view of the first embodiment of the supporting device of the present invention;

FIG. 3 is another partial perspective view of the first embodiment of the supporting device of the present invention;

FIG. 4 is a side view of the second embodiment of the supporting device of the present invention;

FIG. 5 is a partial sectional view of the second embodiment of the supporting device of the present invention;

FIG. 6 is an illustration of movement of the second embodiment of the supporting device of the present invention;

FIG. 7 is a side view of the third embodiment of the supporting device;

FIG. 8 is a partial sectional view of the third embodiment of the supporting device of the present invention;

FIG. 9 is a side view of the third embodiment of the supporting device of the present invention.

### DETAILED DESCRIPTION OF THE PREFERRED EMBODIMENT

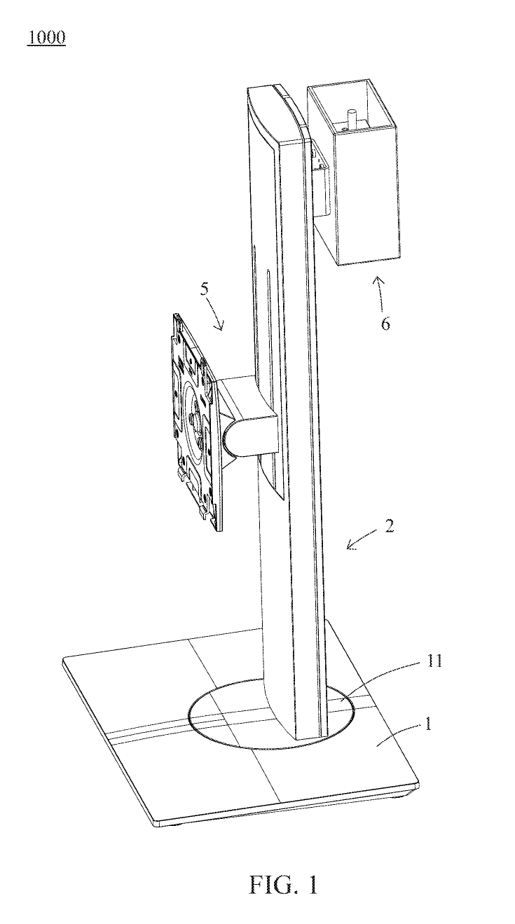

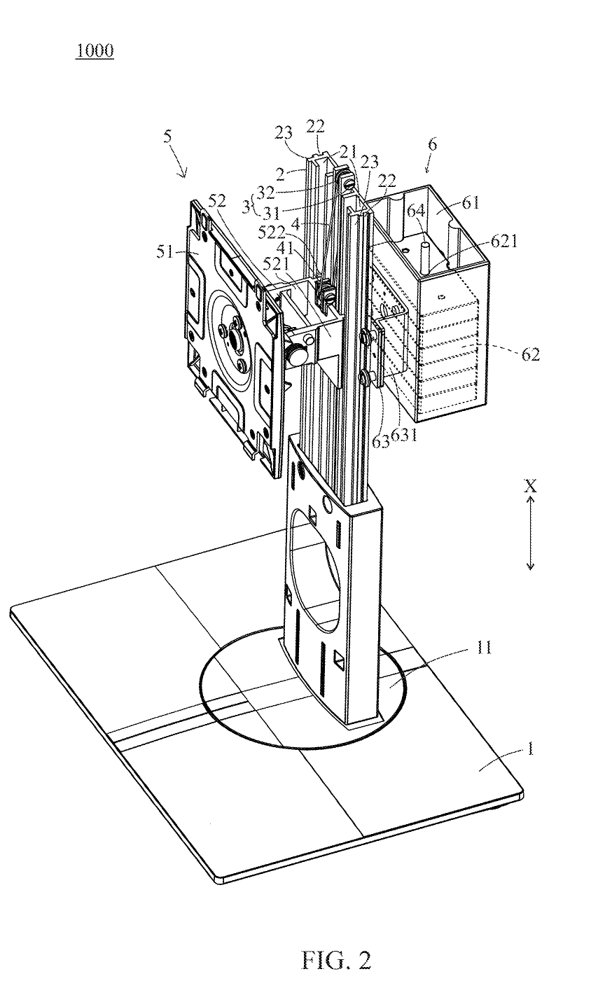

With reference to FIGS. 1 to 3, the first embodiment of the supporting device 1000 according to the present invention includes a base 1, an upright 2, a diverting member 3, a connecting element 4, a holder 5 and an adjustable counter-weight module 6.

The upright 2 is disposed on the base 1. In this embodiment, the upright 2 is installed on a rotating plate 11 of the base 1, so that the upright 2 may rotate with respect to a horizontal surface. In another embodiment of the present invention, the base 1 does not include the rotating plate 11. The upright 2 includes two first sliding grooves 21 and two second sliding grooves 22, wherein the first sliding grooves 21 are formed on a side of the upright 2 neighboring to the holder 5. The second sliding grooves 22 are respectively formed on two opposite sides 23 of the upright 2.

The diverting member 3 includes an axle body 31 and a pulley 32, wherein the axle body 31 is attached to the top of the upright 2, the pulley 32 is sleeved on the axle body 31 and may rotate with respect to the axle body 31. The connecting element 4 is a steel rope in this embodiment, and it may be a drawstring, a belt or similar in other embodiments. The connecting element 4 has a first end 41 and a second end 42 corresponding to the first end 41. The connecting element 4 is partially disposed around the diverting member 3, wherein the first end 41 is connected to the holder 5, and the second end 42 is connected to the adjustable counter-weight module 6. Therefore, the diverting member 3 is a fixed pulley structure in this embodiment.

The holder 5 includes a holding plate 51 and a first sliding element 52, wherein the holding plate 51 is disposed on the first sliding element 52 for holding a display (not shown in the figures). One end of the first sliding element 52 has two first wings 521 and four first friction members 522. The first friction members 522 are respectively disposed on the first wings 521. Two of the first friction members 522 are slidably installed in one of the first sliding grooves 21, and other two of the friction members 522 are slidably installed in the other first sliding groove 21.

The adjustable counter-weight module 6 includes a housing 61, a plurality of presetting counter-weight units 62, a weight bearing unit 63 and a positioning rod 64. The presetting counter-weight units 62 are counter-weight blocks in this embodiment, but they may be weights in other embodiments. In this embodiment, the weight bearing unit 63 is a sliding cart disposed on the upright 2, and the housing 61 is disposed on the weight bearing unit 63. The weight bearing unit 63 has two second wings 631 and four second friction members 632 on one end. The second friction members 632 are respectively disposed on the second wings 631. Two of the second friction members 632 as a pair are slidably installed in one of the second sliding grooves 22, and other two of the second friction members 632 are slidably installed in the other second sliding groove 22. The positioning rod 64 is disposed in the housing 61, and each of the counter-weight units 62 has a hole 621. A user may utilize the hole 621 to locate the positioning rod 64 to put the counter-weight units 62 into the housing 61 individually. It should be noted that the number of the counter-weight units 62 defined the same even when part of the counter-weight units 62 is removed from the housing 61. For example, if the presetting counter-weight units 62 are five blocks, and the user removes three of the blocks from the housing 61, the counter-weight units 62 still mean all five blocks when referred thereto.

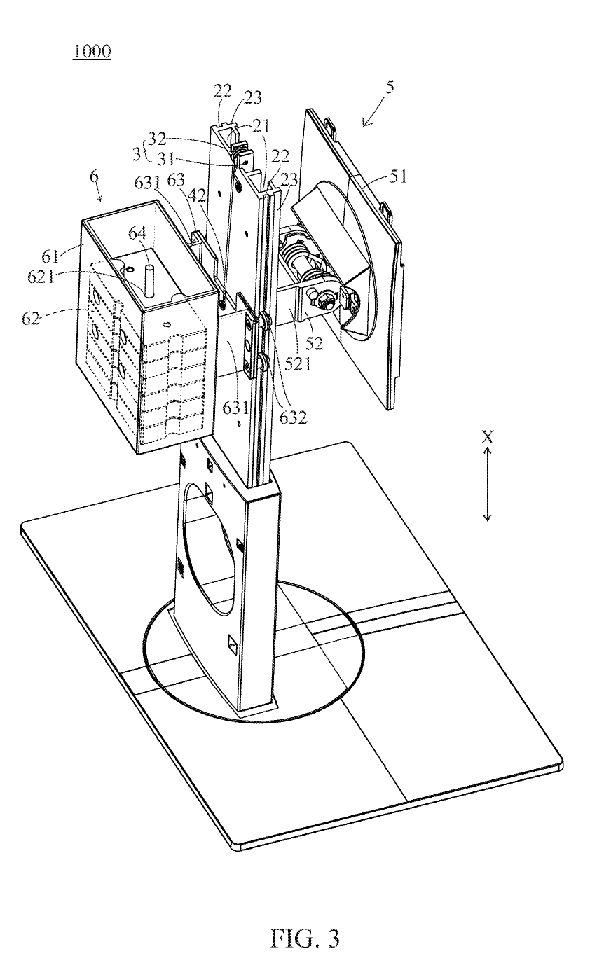

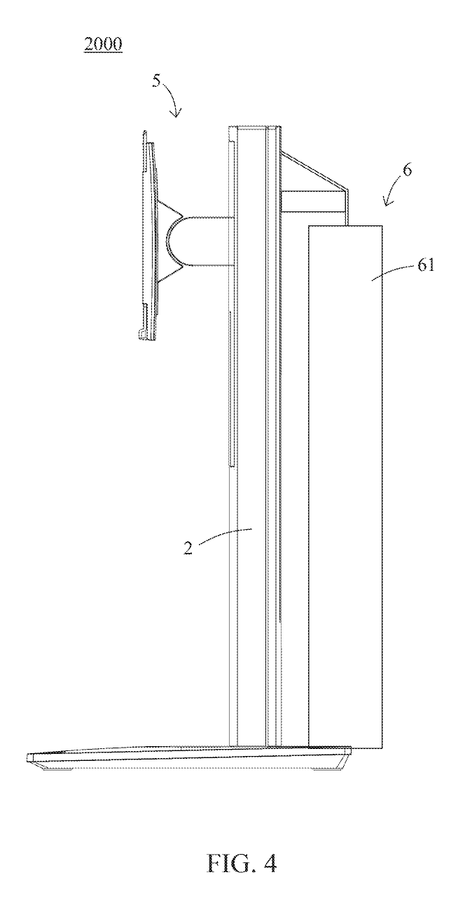

With reference to FIGS. 3 and 4, when an external force is applied downwards on the display and the holder 5, the display and the holder 5 drop along a first axis X relative to the upright 2, driving the first end 41 of the connecting element 4 to be pulled downwards and causing the diverting member 3 to roll, hence the second end 42 of the connecting element 4 moves upwards along the first axis X. Subsequently, the weight bearing element 63 also moves upwards, and the housing 61 and the counter-weight units 62 therein also move upwards. On the contrary, when an external force is applied upwards on the display and the holder 5, the display and the holder 5 raise along the first axis X relative to the upright 2, the first end 41 of the connecting element 4 is driven to be pulled upwards, the diverting member 3 is driven to roll, and hence the second end 42 of the connecting element 4 moves downwards along the first axis X. Subsequently, the weight bearing element 63 also move downwards, and the housing 61 and the counter-weight units 62 therein also move downwards. The first axis X is in parallel with the extending direction of the upright 2 in this embodiment, but the first axis X could be in an angle of 45 degrees or any angle between 0 to 90 degrees relative to the extending direction of the upright 2.

The adjustable counter-weight module 6 and its weight adjusting methods are detailed hereafter. In this embodiment, the number of the counter-weight units 62 is adjusted in accordance to the total weight of the display and the holder 5, so that the total weight of the adjustable counter-weight module 6 can be approximately equal to the total weight of the display and the holder 5. Considering frictions between various elements, the total weight of the display and the holder 5 does not necessarily have to equal to the total weight of the counter-weight module 62. If the weight of the adjustable counter-weight module 6 is lighter than the total weight of the display and the holder 5, the number of the counter-weight units 62 in the housing 61 needs to be added; if the weight of the adjustable counter-weight module 6 is heavier than the total weight of the display and the holder 5, the number of the counter weight units 62 in the housing 6 needs to be reduced. Through adjusting the number of the counter-weight units 62 described above, the display may slide relative to the upright 2 and stop at any selected position. In other words, force equilibrium is achieved to maintain the position of the display by presetting the number of the counter-weight units 62 moving with the connecting element 4.

It has to be noted that this embodiment emphasizes on adjusting the number of the counter-weight units 62 in order to make the display stop at any position relative to the upright 2, but does not limit the total weight of the adjustable counter-weight module 6 to approximate to the total weight of the display and holder 5. For example, a moving pulley may be added to the supporting device 1000 in this embodiment, so that the adjustable counter-weight module 6 only needs to be half of the total weight of the display and the holder 5. Thus only one or more of the counter-weight units 62 need to be removed from the housing 61 to reduce the weight of the adjustable counter-weight module 6, and still enable the display to stop at any position relative to the upright 2 according to the structure of this embodiment.

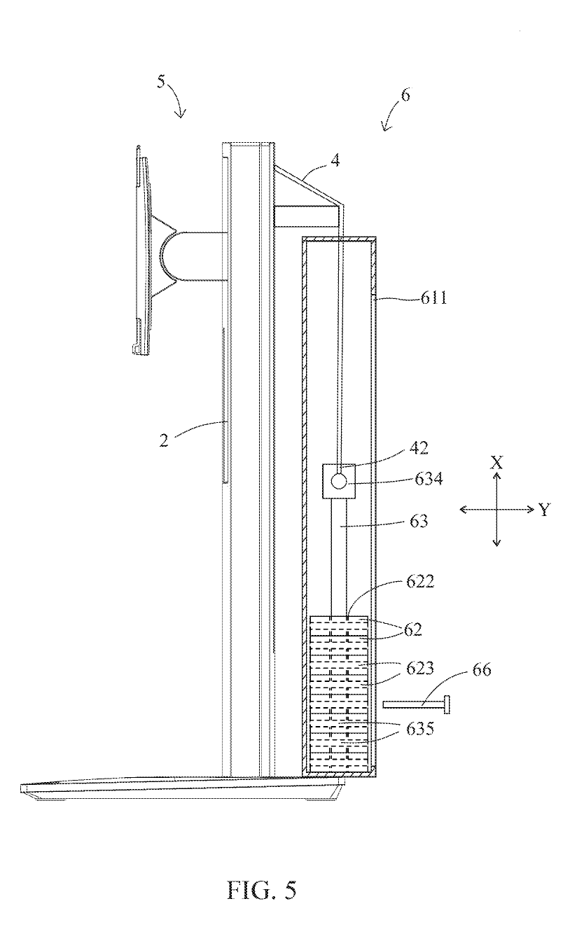

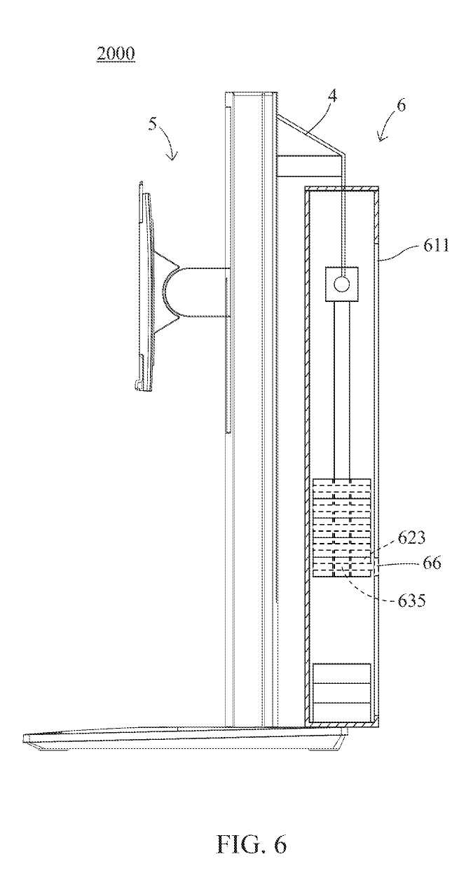

FIGS. 4 to 6 are illustrations of the supporting device 2000 in the second embodiment according to the present invention. In this embodiment, structures of and connecting relationships between the holder 5, the connecting element 4, and the upright 2 are the same as in first embodiment. The difference between the first embodiment and this embodiment is on the structure of the adjustable counter-weight module 6. In this embodiment, the adjustable counter-weight module 6 includes a housing 61, a weight bearing element 63, a pin 66, and a plurality of counter-weight units 62. In this embodiment, the weight bearing element 63 is a moving rod. The second wings 631 and the second friction members 632 of the weight bearing element 63 in the first embodiment are omitted. The housing 61 has a through groove 611. The first end 41 of the connecting element 4 is connected to the holder 5, the weight bearing element 63 is in the housing 61, and the second end 42 of the connecting element 4 is directly connected to an end 634 of the weight bearing element 63. Each of the counter-weight units 62 has a first hole 622 and a second hole 623. The weight bearing element 63 has a plurality of third holes 635. The weight bearing element 63 passes through the first holes 622 of the counter-weight units 62 along the first axis X. The pin 66 penetrates the through groove 611 of the housing 61, and passes in one of the second holes 623 and one of the third holes 635, which is corresponding thereof, along a second axis Y perpendicular to the first axis X. In other words, the pin 66 is used to determine the number of counter-weight units 62 to move together with the weight bearing element 63. As shown in FIG. 5, when an external force is applied downwards on the display (not shown in the figures), the display and the holder 5 drop along the first axis X relative to the upright 2 to make the connecting element 4 drive the weight bearing element 63 to raise relative to the upright 2 along the first axis X. If the plurality of counter-weight units 62 between the pin 66 and the end 634 of the weight bearing element 63 is just sufficient to enable the display to stop at any selected position relative to the upright 2, it is not necessary to adjust the number of counter-weight units 62 moving with the weight bearing element 63. If not, the number of counter-weight units 62 moving with the weight bearing element 63 may be added or reduced by changing the position of the pin 66, until the display may stop at any selected position with respect to the upright 2.

The first embodiment is simply to place or remove the counter-weight units 62 in the housing 61 to determine the number of counter-weight units 62; wherein the second embodiment is to insert pin 66 to determine the number of the counter-weight units 62 moving with the weight bearing element 63.

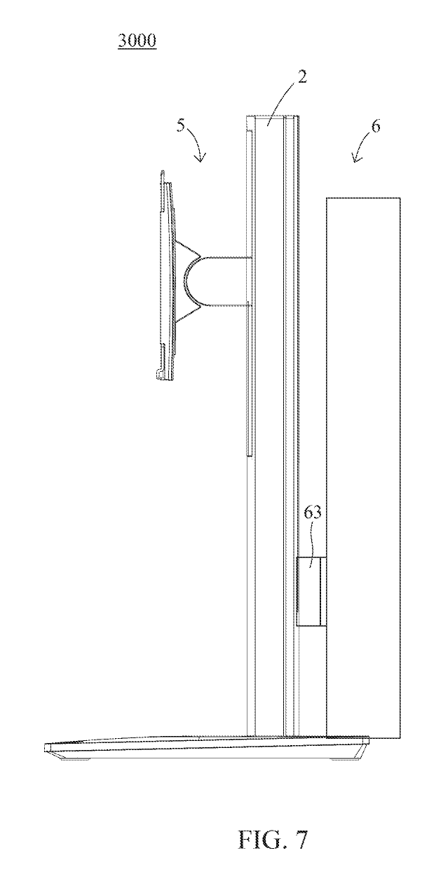

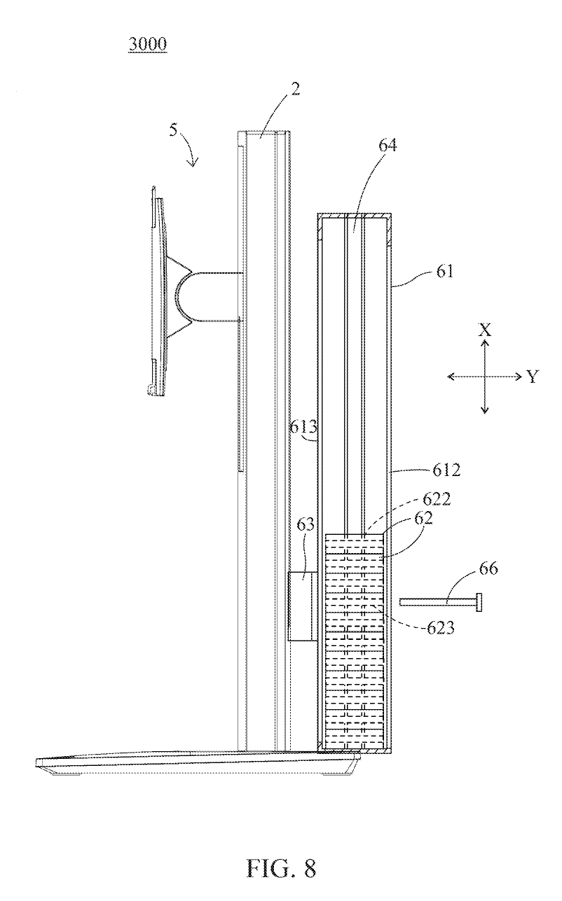

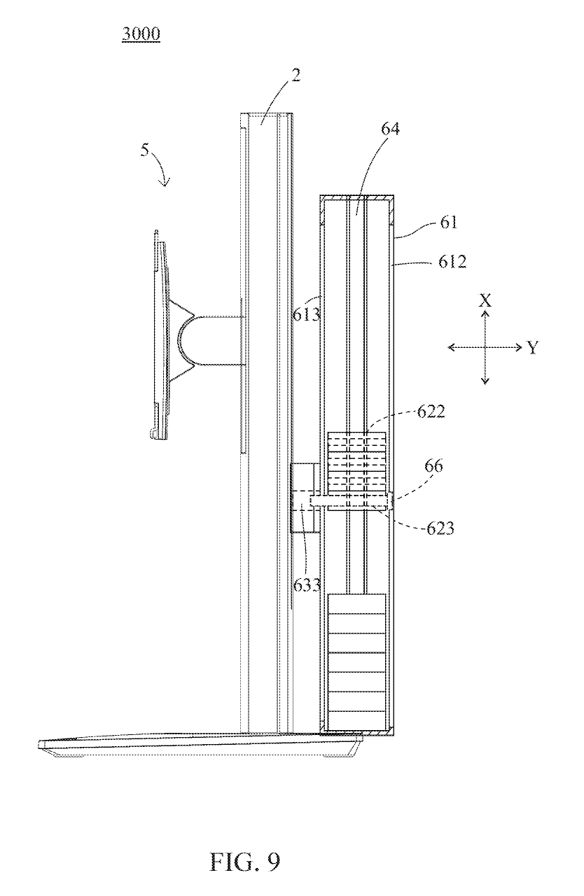

FIGS. 7 to 9 are illustrations of the supporting device 3000 of the third embodiment according to the present invention. In this embodiment, the structures of and connecting relationships between the holder 5, the connecting element 4 and the upright 2 are the same as in first embodiment. The adjustable counter-weight module 6 of this embodiment includes a weight bearing element 63, a housing 61, a pin 66, a positioning rod 64 and a plurality of counter-weight units 62. The weight bearing element 63 of this embodiment has the same structure as the weight bearing element 63 of the first embodiment, and the manner of contacting the upright 2 is also the same. The positioning rod 64 is disposed in the housing 61 for the counter-weight units 62 to be sleeved thereto. The housing 61 includes a first through groove 612 and a second through groove 613 corresponding to the first through groove 612. The first through groove 612 and the second through groove 613 both extend along the first axis X. The weight bearing element 63 includes a fourth hole 633. The pin 66 penetrates the first through groove 612 along the second axis Y, one of the second holes 623, the second through groove 613, and the fourth hole 633 in sequence, so that part of the counter-weight units 62 slides along with the weight bearing element 63. As shown in FIG. 9, when the display (not shown) and the holder 5 move downwards along the first axis X relative to the upright 2, the connecting element 4 is driven to move the weight bearing element 63 upwards along the first axis X, and the counter-weight units 62 above the pin 66 raise with the weight bearing element 63. The counter-weight units 62 above the pin 66 move along the positioning rod 64. If the counter-weight units 62 above the pin 66 are just sufficient to enable the display to stop at any selected position relative to the upright 2, it is not necessary to adjust the number of counter-weight units 62 moving with the weight bearing element 63. If not, the number of counter-weight units 62 moving with the weight bearing element 63 may be added or reduced by changing the position of the pin 66, until the display may stop at any selected position.

In other embodiments of the present invention, the adjustable counter-weight module 6 may further includes a computer, wherein the weight of the computer is added to that of the plurality of the counter-weight units 62 and also contributes to enable the display to stop at any selected position which is not further explained herein.

It is concluded that the supporting device of the present invention is equipped with an adjustable counter-weight module, and the displays of different weights are adopted by adjusting the number of counter-weight units of the adjustable counter-weight module. Hence the utilities of the supporting device of the present invention are made simpler and more versatile.

Although the present invention and its technical characteristics have been explained in relation to its preferred embodiments, it is to be understood that many other possible modifications and variations can be made by persons having ordinary skill in the art without departing from the spirit and scope of the invention as hereinafter claimed.

What is claimed is:

1. A supporting device for supporting a display, the supporting device comprising:
an upright;
a diverting member, being disposed on the upright;
a connecting element, being partially disposed around the diverting member;
a holder, being slidably disposed on the upright, connecting to the connecting element, and supporting the display; and
an adjustable counter-weight module, being connected to the connecting element and including a plurality of counter-weight units, wherein the display, the holder, and the adjustable counter-weight module are in a static balancing state through a presetting number of the counter-weight units moving along with the connecting element;
wherein the display is able to move relative to the upright and leads the connecting element to drive the counter-weight units to move simultaneously when an external force is applied to the display, and the display is stopped relative to the upright at any position when the external force is removed.

2. The supporting device of claim 1, wherein the adjustable counter-weight module further includes a weight bearing element connected to the connecting element, wherein the connecting element leads the weight bearing element to move down or up, and at least one of the counter-weight units moves down or up along with the weight bearing element when the display moves up or down relative to the upright.

3. The supporting device of claim 2, wherein the adjustable counter-weight module further includes a pin, the counter-weight units are disposed stacked, each of the counter-weight units has a first hole and a second hole, and the pin is adapted to selectively insert into the second hole of any one of the counter-weight units.

4. The supporting device of claim 3, wherein the adjustable counter-weight module further includes a housing, wherein the counter-weight units are disposed therein.

5. The supporting device of claim 4, wherein the weight bearing element includes a plurality of third holes and passes through the first holes of the counter-weight units along a first axis, and the second holes correspond to the third holes for the pin penetrating through a through groove of the housing to insert in one of the second holes, so that while the external force is driving the display and the holder to move up or down relative to the upright, the connecting member leads the weight bearing element to move down or up, and simultaneously drives the counter-weight units between one end of the weight bearing element and the pin to move down or up.

6. The supporting device of claim 4, wherein the upright includes a first sliding groove and a second sliding groove, and the holder includes a first sliding element, wherein a plurality of first friction elements of the first sliding element and a plurality of second friction elements of the weight bearing element are respectively disposed in the first sliding groove and the second groove, the weight bearing element is connected to the connecting element and disposed between the upright and the housing, and when the holder is moving relative to the upright, the first friction elements slide in the first sliding groove and the second friction elements slide in the second sliding groove.

7. The supporting device of claim 6, wherein the housing includes a first through groove and a second through groove corresponding to the first through groove, and the weight bearing element further includes a fourth hole, wherein the pin sequentially penetrates the first through groove, one of the second holes, the second through groove and the fourth hole, and while the holder is moving up or down relative to the upright, the connecting member drives the weight bearing element to move down or up, and the counter-weight units above the pin move up or down simultaneously.

8. The supporting device of claim 7, wherein the adjustable counter-weight module includes a positioning rod for the counter-weight units to be sleeved thereto, and the counter-weight units are adapted to move up or down with respect to the positioning rod.

9. The supporting device of claim 1, wherein the connecting element has a first end and a second end corresponding to the first end, wherein the holder is connected to the first end, and the adjustable counter-weight module is connected to the second end when the connecting element is partially disposed around the diverting member.

10. The supporting device of claim 1, wherein the diverting member is a fixed pulley structure.
